(19) United States
(12) Patent Application Publication
(10) Pub. No.: US 2006/0158514 A1
(43) Pub. Date: Jul. 20, 2006

(54) Portable camera and digital video recorder combination

(76) Inventor: Philip Moreb, Rancho Mirage, CA (US)

Correspondence Address: Mitchell B. Wasson;HOFFMAN, WASSON & GITLER, P.C., Suite 522, 2461 South Clark Street, Arlington, VA, 22202, US

(21) Appl. No.: 11/260,437

(22) Filed: Oct. 28, 2005

Related U.S. Application Data
(60) Provisional application No. 60/622,598, filed on Oct. 28, 2004.

(51) Int. Cl. H04N 7/18

(52) U.S. Cl. 348/153

(57) ABSTRACT

A portable camera and receiver combination is disclosed for displaying video signals on a real time basis or recording these signals directly onto a digital video recorder. This system could be used in the field of forensics as well as surveillance. Various wired or wireless cameras would transmit information to a carrying case including a display monitor as well as a digital video recorder. Various controls container in the interior of the carrying case would be used to operate the system of the present invention.

### CROSS-REFERENCED APPLICATION

The present application claims the priority of Provisional Patent Application Ser. No. 60/622,598 filed Oct. 28, 2004.

### FIELD OF THE INVENTION

The present invention is directed to the field of forensics as well as surveillance utilizing a wireless or wired camera in communication with a digital video recorder (DVR).

### BACKGROUND OF THE INVENTION

While the field of criminal forensics has been under development for a long period of time, it has recently gained in publicity in large part due to the recent popularity in television programs emphasizing this scientific endeavor. Shows like CSI, CSI Miami and CSI New York have spotlighted this increasingly important branch of science. These shows stress the use of very modern technology in processing a crime scene. It is interesting to note that the majority of police forces throughout the country are not in possession of many of the scientific tools utilized in these shows. Therefore, many individuals on a jury are surprised that, during the course of a criminal trial, these tools are not presented to them during the course of the trial, since many of the jurisdictions are not in possession of these ultramodern scientific tools.

The use of a forensic camera used in adult child abuse situations as well as in other fields of criminal investigation has been found wanting due to evidentiary problems. In the past, the images generated by a forensic camera were stored on a VHS tape, generally with the forensic camera directly wired to the VHS tape. However, VHS tapes suffered from the fact that these tapes can be altered in many ways and therefore are not always regarded as being concrete evidence. Additionally, cameras which have been utilized with VHS tapes itself have had problems in providing the proper resolution in the field of forensic exams. This is true since if there is a small movement in the image field, then a higher resolution image can be calculated to produce a super resolution image. Cameras currently in the medical forensic field magnify the images with an interpolation method which takes sub pixel resolution into account.

Furthermore, with respect to a sexual abuse exam, most doctors submit a written report with the VHS video to the court. However, it has been suggested to watch the video sequencing of a patient before submitting any evidence. In this instance, it has been recommended to send a composite video to the court. The problem with this is that an attorney might inquire as to whether there has been any tampering with the VHS tape to produce this composite video. Additionally, the type of camera which has been previously utilized would not be able to provide the type of resolution which would be required. Furthermore, prior art forensic cameras were directly connect to the VHS tape thereby providing an unwieldy combination. Lastly, the lack of portability of any recording unit would make it difficult to properly process a crime scene.

A number of United States patent applications as well as United States patents have, in an ancillary manner, indicated that a digital video recorder (DVR) can be used in the forensic field. For example, U.S. Patent Application Publication 2005/0019000 to Lim et al. describes a method of restoring and reconstructing high resolution images from low resolution compressed images. This application does indicate that super resolution images could be utilized in various fields, including forensics. It is also noted that digital video recorders are currently replacing the CCTV system used to magnify objects in a scene such as a face of a criminal or the license plate of a car.

The patent application publication 2004/0130620 to Buehler et al. describes a method and system for tracking and monitoring multiple objects. A block diagram of a video analysis system is illustrated with respect to FIG. 3. This block diagram includes a receiving module 302, a tracking module 304, a classifier 306 and a rules engine 308. It is indicated that the tracking module 304 can operate in real time or in a forensic mode. In the forensic operation, the tracking module analyzes previously recorded video(e.g., from a video cassette or a digital video recorder, etc.) of a monitored environment. If the tracking module 304 is tracking objects in real time, the tracking module can update a tracking solution after a track graph construction process is completed for each time instant analyzed.

United States patent application publication 2002/0106998 to Presley et al. is directed to a wireless conferencing system which can stress the applicability to forensics. Although this application does indicate that it does have some usefulness in the field application such as crime scenes, remote detection facilities or battlefields where the underlying infrastructure is likely lacking, it does not detail the type of camera which would be employed.

Unites States patent application 2005/0102704 to Prokupets et al. describes a security system utilizing a plurality of video cameras 24 installed in or around areas of buildings or outside of buildings. These video cameras 24 are each coupled for data communication with a digital video recorder (DVR) 26 for storage of video date captured by the cameras. The DVRs are connected to a regional service 16 via a LAN 23 using the appropriate hardware and software. The DVR 26 can either be a digital video recorder 26a for analog-base cameras or an IP network digital video recorder 26b for digital-base cameras.

Although some of the aforementioned United States patent application publications do, in an oblique manner, mention the fact that a DVR can be used in forensics or crime scene investigation, none of these patent application publications describe a system in which a super resolution forensic wand camera is provided with a wireless connection to a digital video recorder (DVR), as well as describe a system containing a portable unit including a DVR connected to a wireless or wired camera.

### SUMMARY OF THE INVENTION

The deficiencies of the prior art are addressed by the present invention which includes a hand held forensic camera in wireless or wired communication to a digital video recorder (DVR). While this camera can be utilized in any type of crime scene invention, it would also have particular applicability in the field of medical investigation, including sexual abuse cases. The hand-held forensic camera would utilize a lens allowing the camera to magnify and scan, for example, the skin one inch above the surface to determine the existence of any marks, scratches, bruises, cuts or the like. The forensic camera is provided with a wireless or wired connection to a DVR recording unit produced within a case situated at a location removed from the camera. As can be appreciated, the distance between the camera and the DVR recording unit provided in the carrying case is a function of the power of the signal generated by the forensic camera. A screen is provided within the carrying case which is used to visualize the image produced by the forensic camera. In real time, or to view the image recorded on the DVR recording unit, this screen can also be utilized to display various menus which would be utilized to operate the entire system including the forensic camera and the DVR. The instruments within the carrying case can be operated by directly connecting the carrying case to a power source, or can be operated through the utilization of batteries provided within the carrying case. A plurality of control switches and indicators are provided in the carrying case which are used to control the operation of the forensic camera, the DVR as well as the manner in which material is displayed on the screen. In this context, it can be appreciated that the screen can be split, thereby depicting different camera images produced by a single forensic camera or by a plurality of forensic cameras. The carrying camera and the instruments in the carrying case would include a zoom function for magnifying the image stored on the DVR, or produced in real time by the camera.

Although the present invention has been described to be utilized in the field of forensics including forensic medicine, its application should not be so limited. For example, particularly with use with wireless camera, it would have applications in the field surveillance. For example, a number of cameras could be utilized in an area in which the possible theft of various material can be observed. Furthermore, the cameras and the DVR of the present invention can be employed by a SWAT Team during negotiations with various alleged criminals.

### BRIEF DESCRIPTION OF THE DRAWINGS

These and other objects, features and many of the attendant advantages of the present invention will be better understood upon a reading of the following detailed description when considered in connection with the accompanying drawings, wherein like parts in each of the several Figures are identified by the same reference number, and wherein:

FIG. 1 is a front view of the carrying case including the DVR, also including a view of a wireless camera used in conjunction with the system of the present invention;

FIG. 2 is a view showing the bottom interior of the carrying case;

FIG. 3 is a perspective view showing the top portion of the interior of the carrying case;

FIG. 4 is a view showing the rear portion of the carrying case;

FIG. 5 is a schematic view showing the controls used in the carrying case of the present invention; and

FIG. 6 is a view showing the rear panel connectors of the present invention.

### DETAILED DESCRIPTION OF THE PRESENT INVENTION

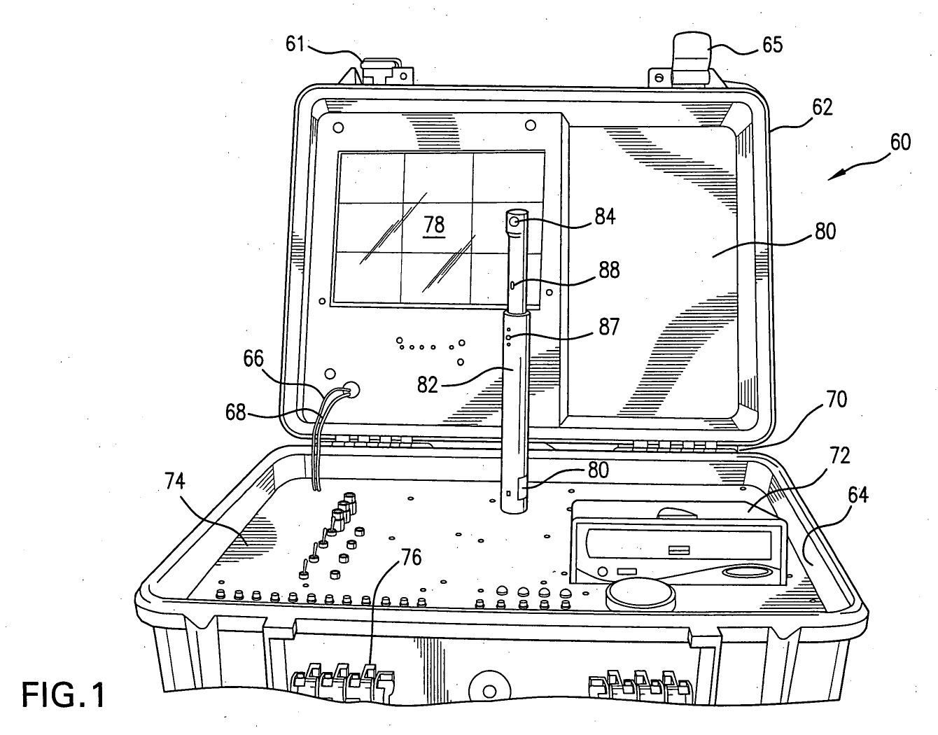

FIGS. 1-4 illustrates the physical embodiment the present invention which includes a carrying case 60, a digital video recorder (DVR) 72, and a hand held camera 82, in communication with the equipment in the carrying case 60, through a wireless connection. Alternatively, as will be subsequently described, a camera which is directly attached to the carrying case could also be utilized. The DVR 72 would have a hard drive, such as an 80 GB to 320 GB built in that records actual real time information that cannot be altered. The DVR 72 as well as the controls of the carrying case, as will be subsequently explained, operate utilizing a CDRW in communication with the hard drive or by the utilization of a ST card that is inserted into a computer in which images are directly printed from the hard drive.

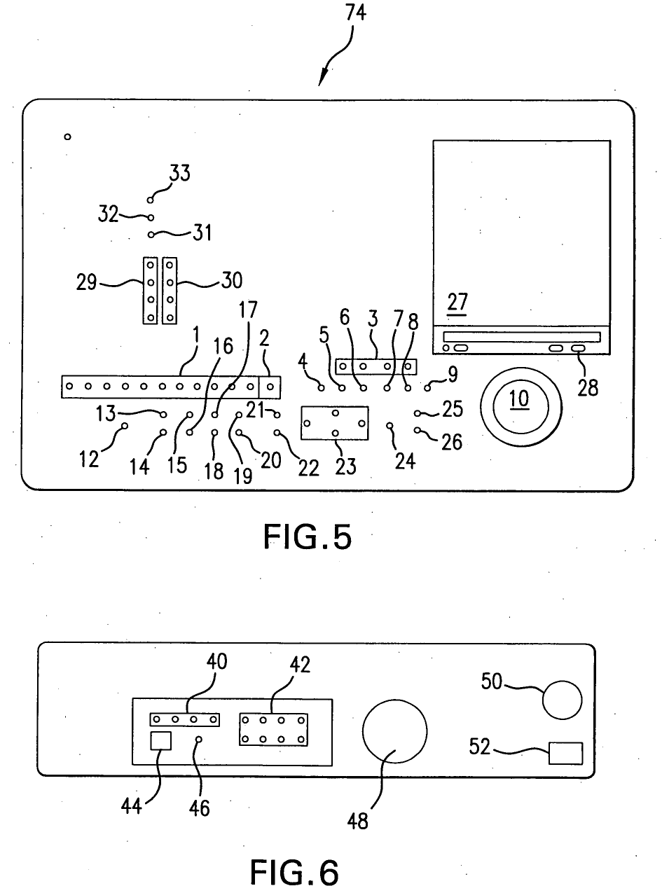

The carrying case 60 is provided with a top cover 62 and a base unit 64. The cover portion 62 is hingedly attached to the base portion 64 utilizing hinges 68 and 70. Two locks 61, 63 are attached to the cover 62 and cooperate with units 65, 67 provided on the base portion 64 to secure the carrying case 60 in a closed position. The carrying case can be formulated from a light weight polymeric resin material with superior strength designed to exceed all military standards. The carrying case is airtight, watertight and includes an O-ring seal pressure equalizer value. The cover 62 of the carrying case is provided with a screen 78 applied to a portion of the interior of the carrying case top. As shown in FIG. 1, the screen 78 can simultaneously display a plurality of images. The DVR 72 is fixedly attached to the bottom 64 of the carrying case. A section 80 of the top of the carrying case 62 is recessed to accommodate the DVR 72 therein when the carrying case is in the closed position. The top surface of the bottom of the carrying case is provided with a control panel section 74. The various switches and dials and indicators in this control panel section will be explained with respect to FIG. 5.

The camera utilized in the present invention can be directly hard wired to the carrying case or would be wirelessly in communication with the DVR within the carrying case. One type of camera 82 which is in wireless communication with the DVR 72 is shown in FIG. 1. This camera includes a lens 84 including a built-in zoom with auto focus. A power switch 80 is utilized to initiate operation of a camera 82. A pinhole lens 84 is used to receive information which is then wirelessly transmitted to the DVR 72 for storage therein or for real time depiction on the display 78. Switch 88 would be used to control the illumination of a plurality of lights 87. These lights would not be illuminated if the unit was used in a covert type operation.

Although various types of wireless cameras can be utilized, two types of cameras have been found to be particularly useful. One type of camera would utilize a 20 mm lens which would allow, when used as a medical forensic camera to magnify skin one inch above its surface as well a zooming in to identify any marks, scratches, bruises or cuts.

A second type of wireless camera which has been utilized with this invention would include a 200 mm lens. However, it should be noted that the exact type of camera employed by the present invention is not of paramount importance. In fact, a multitude of wireless cameras can be utilized as well as a multitude of hard wired cameras. With respect to the wireless type of camera, it is generally been found that a range of 500 to 700 feet, line of sight, has proven to be sufficient.

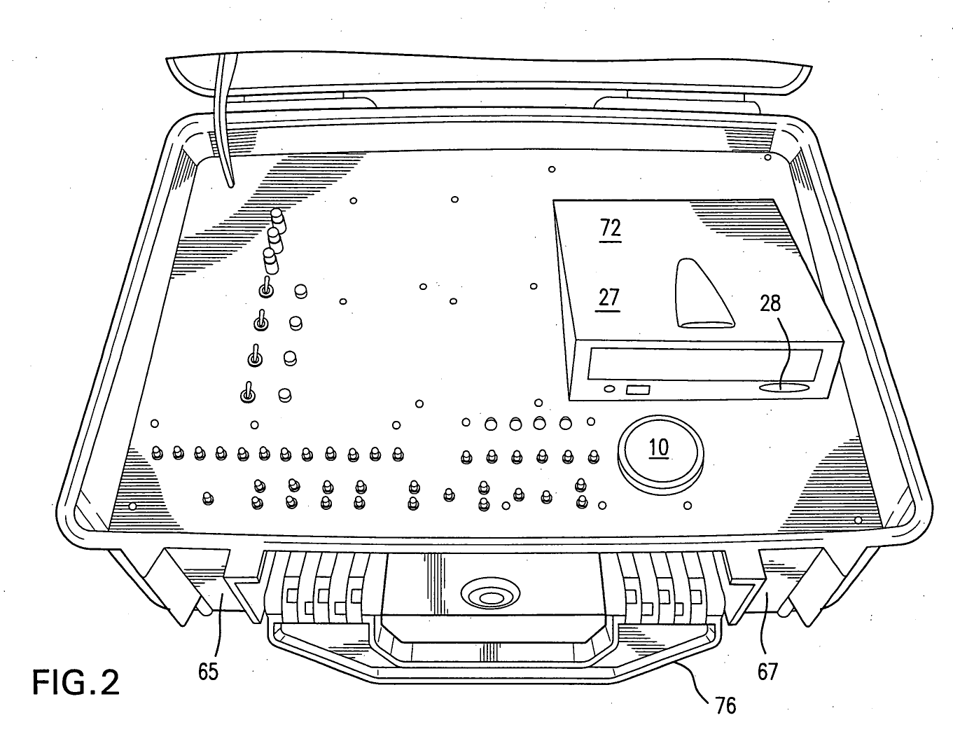

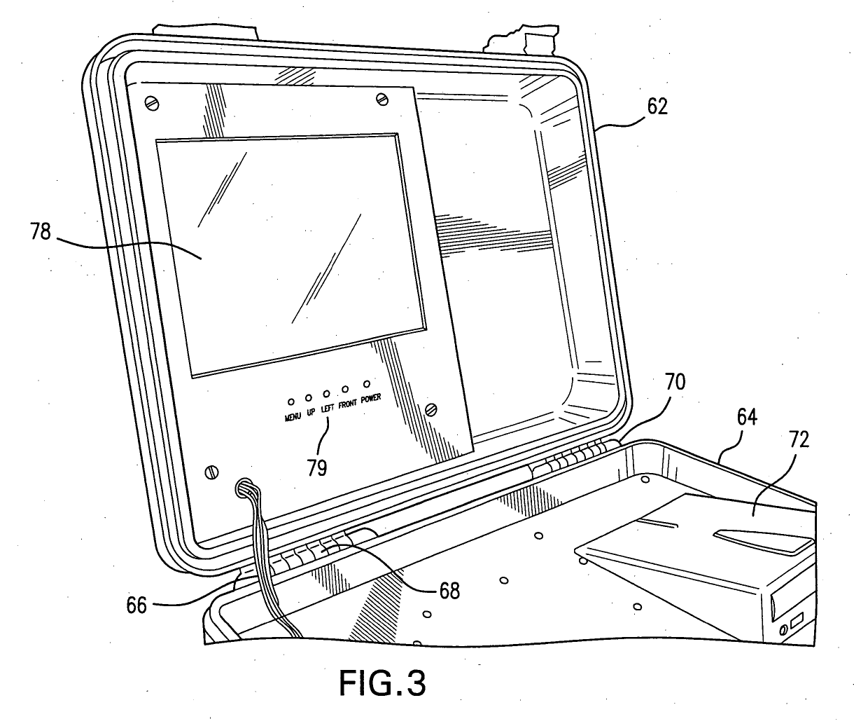

As shown in FIG. 2, a heavy duty handle 76 will be utilized to transport the carrying case. Additionally, the DVR 72 would be provided with CD writer as well as an eject button used to eject the CD tray. The top of the case, as shown in FIG. 3, would include a control panel 79 used directly with respect to the monitor screen 78. These controls would allow the monitor to operate in the S Mode as well as an auxiliary mode and would include a separate power control. Information to be displayed on the monitor screen 78 would be conveyed thereto through the use of a wire connection 66 between the monitor screen 78 and the DVR controls.

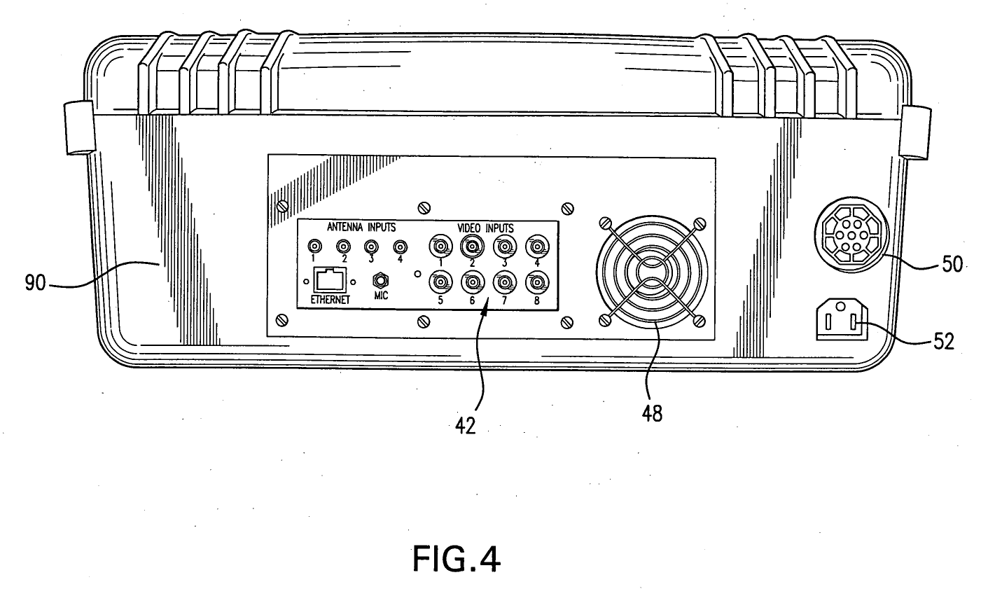

The rear of the case, as depicted in FIG. 4 would include a rear connection panel 92, as will be explained herewith as well as an exhaust cooling fan 48, a power supply vent 50 and an 110 volt AC power socket 52 to allow the instruments within the carrying case to be operated when connected to a wired power source. Alternatively, the carrying case could be included with a standard rechargeable battery for operating the entire system.

FIG. 5 illustrates the front panel controls 74 provided on the base 64 of the carrying case. These controls are utilized to operate the system including information transmitted from one or more wireless or hard wired cameras, display this information on the monitor displays 78 as well as record this information on the DVR. Since it is important to restrict operation of this device only to authorize personnel to ensure that any information displayed on the monitor 78 or recorded in the DVR is not compromised, a password must be entered into the system to allow the system to be properly initialized. A series of toggle switches 1-9, 10/0, +10 1 are used to enter a password authorizing the use of this system. Additionally, as indicated hereinabove, a plurality of cameras can provide information to be displayed on the monitor 78 as well as to be recorded in the DVR 72. In conjunction with display toggle 2, the toggles 1 will be utilized to indicate that the system will be operating in a split screen mode and the toggles 1 will be utilized to indicate which cameras would display their transmitted output on the monitor 78. Indicators 3 are used to display the mode in which the system is operating. These modes include a power mode indicating that a power switch 12 has been engaged, a recording switch indicating that a recording button 4 has been engaged, a schedule recording indicator depicting the fact that a scheduled recording will occur and a lock mode, thereby preventing operation of the system. In conjunction with the recording button 4, a stop button 5 would stop the recording of the information received from one or more of the cameras. A play/reverse play button 6 is utilized to play back the recorded information as well as to reverse the play back mode when the play/reverse play button 6 is pressed again. A still button 7 is included to still the displayed image during the play back mode. If an audio input is included with the visual input from one or more of the cameras, audio play back button 8 is employed to help synchronize the audio sound track with that particular scene.

A shuttle hold button 9 is employed for retaining the selected play back or reverse play back speed in conjunction with the rotation of a jog and shuttle dial 10 to a desired search speed. The shuttle hold button 9 can then depressed holding the shuttle dial 10 at the selected search speed. It is noted that search speed will be maintained even when the shuttle dial 10 is returned to its original position. The shuttle dial 10 is also used to set various menus and search functions which would be displayed on the monitor screen 78. The shuttle dial is also used to forward and image during play back in a field by field manner.

Lock button 13 is used to prevent the use of the present device by all unauthorized personnel. When this button is suppressed, the lock LED among the mode indicators 3 will be illuminated. When the lock button is again pressed, the lock LED will be shut off and various functions can be engaged only when the appropriate pass word is again entered utilizing the toggle switches 1.

A zoom button 14 is used to display a zoom area box in the screen monitor 78. By pressing this button in various manners, the image can be further enlarged. Through the use of cursor switches 23, the zoom area can be moved on the display screen 78.

Restore button 15 is used to restore recorded data to the main hard disk from the CD writer. The backup button 16 is employed to initiate the making of a backup copy of the hard drive to the CD writer. Button 17 is used to make a scheduled recording. This button 17 is used in conjunction with the toggle switches 1 to schedule this recording. When the schedule button has been engaged, the appropriate schedule LED would be illuminated in the mode indicator section 3. Buttons 19 and 20 would be utilized to display an information list as well as a log list respectively.

A menu button 21 is used to display the main menu screen on the display monitor 78. Utilizing the various cursor buttons 23, would allow an individual to navigate through the various menus which would be depicted on the screen monitor 78. The menu button 21 is also used as an exit button to all kinds of OSD screens. An Enter/Channel, selection button 22 is employed to confirm a new setup on the menu as well as to switch to various channel display modes.

A Cancel/OSD off button 24 is used to cancel a new setup on the menu. When the system is in the zoom mode, pressing this button would zoom out to the image. In the stop mode and the play back mode, depressing this button would make the OSD disappear. Time/Search button 25 and Alarm search button 26 are used to display a time/search menu as well as an alarm search menu respectively.

As configured in FIGS. 2 and 5, four wireless cameras can be simultaneously or singly used as inputs to the present device. It can certainly be appreciated that more wireless units can be employed. The number of wireless units employed would be based upon the number of wireless antennas contained within the carrying case 60. Each of the antennas would be connected to one of antenna inputs 40 illustrated in FIG. 6. Input toggle switches 29 would be utilized to select the number and channels of the wireless cameras transmitting information to the unit to be displayed in real time or to be recorded on the DVR. Indicators 30 associated with one of the toggle switches 29 would be illuminated to indicate the wireless inputs which have been selected. It is noted that the present invention would utilize a single 2.5 GHz antenna for each of the video inputs.

A plug 31 is included to connect the system to an analog video monitor or to transfer the video system to a back up recorder. Plug 32 would supply analog audio signal from a real time recording or from archived data. Plug 33 would connect an input signal from an analog source, such as a microphone pre-amplifier to record this information onto this hard disk.

FIG. 6 illustrates the rear panel connectors as also shown in FIG. 4. As previously described, antenna inputs 40 would be used to connect any of the supplied antennas to the channel shown in the front panel control 74 that correspond to the transmitter that is going to used. Video inputs 42 are used to connect the video signals produced by a wireless camera or wired camera to the device of the present invention. The present invention as illustrated in FIGS. 4 and 6, include eight video inputs. Although the number and types of these video inputs can change, as shown in FIG. 4, the present invention can operate utilizing eight hard wired cameras or four hard wired cameras and four wireless cameras. The number and type of cameras employed are a function of the number of antennas utilized. Obviously, there must be a single antenna for each of the wireless cameras.

The system is employed with an RJ-45 Ethernet connector 44 for connecting this system to a network. An independent microphone input 46 is also included. As previously described, the present system employs an exhaust cooling fan 48, and an AC power socket 52 used to connect the system to an AC line. Alternative, a rechargeable battery can be used to operate this system. If the system is attached to an AC power socket, the battery would keep all sitting information for a period of time if there is a power failure.

While particular embodiments of the present invention have been shown and described, other embodiments as well as uses will be obvious to those skilled in the art in view of the above disclosure. Changes or modifications to any of the components herein described are still within the scope of the invention. Therefore, the appended claims are to encompass within their scope all such changes and modifications as fall within the true spirit on scope of the invention.

What is claimed is:

1. A portable device for receiving and recording information captured by at least one video camera, comprising:
a carrying case including a base unit and a cover unit attached to said base unit;
a digital video recorder and control device provided within said carrying case;
a receiving means provided within said carrying case for receiving the information captured by the at least one video camera and transmitted to said receiving means, the captured information recorded in a memory device of said digital video recorder; and
a video monitor in communication with said receiving means and said digital video recorder for displaying the information captured by the at least one video camera in real time and for displaying said information recorded in said memory device of said digital video recorder on a time delayed basis.

2. The portable device in accordance with claim 1, further including at least one hinge device connected to said base unit and said cover unit to hingedly attach said cover unit to said base unit.

3. The portable device in accordance with claim 1, wherein said recovery means includes a plurality of antennae, each antenna receiving the information captured by separate wireless video cameras.

4. The portable device in accordance with claim 1, wherein said receiving means includes a plurality of plugs, each of said plugs in wired communication with separate hard-wired video cameras.

5. The portable device in accordance with claim 3, wherein said video monitor simultaneously displays the information captured by more than one of said video cameras.

6. The portable device in accordance with claim 4, wherein said video monitor simultaneously displays the information captured by more than one of said video cameras.

7. The portable device in accordance with claim 5, wherein said digital video recorder simultaneously records the information captured by more than one of said video cameras.

8. The portable device in accordance with claim 6, wherein said digital video recorder simultaneously records the information captured by more than one of said video cameras.

9. The portable device in accordance with claim 1, wherein said information recorded in said digital video recorder is both video and audio.

10. The portable device in accordance with claim 1, wherein said carrying case is provided with a plurality of switches for controlling the operation of said video monitor and said digital video recorder through said control device.

11. A communication system for use in the field of forensics or surveillance, comprising:
at least one video camera capturing information of a particular scene;
a portable carrying case including a base unit and a cover unit attached to said base unit;
a digital video recorder and control device provided in said portable carrying case;
a receiving means provided within said portable carrying case for receiving the information captured by said at least one video camera and transmitted to said receiving means, the captured information recorded in a memory device of said digital video recorder; and
a video monitor in communication with said receiving means and said digital video recorder for displaying the information captured by said at least one video camera in real time and for displaying said information recorded in said memory device of said digital video recorder on a time delayed basis.

12. The communication system in accordance with claim 11, further including at least one hinge device connected to said base unit and said cover unit to hingedly attach said cover unit to said base unit.

13. The communication system in accordance with claim 11, wherein said recovery means includes a plurality of antennae, each antenna receiving the information captured by separate wireless video cameras.

14. The communication system in accordance with claim 11, wherein said receiving means includes a plurality of plugs, each of said plugs in wired communication with separate hard-wired video cameras.

15. The communication system in accordance with claim 13, wherein said video monitor simultaneously displays the information captured by more than one of said video cameras.

16. The communication system in accordance with claim 14, wherein said video monitor simultaneously displays the information captured by more than one of said video cameras.

17. The communication system in accordance with claim 15, wherein said digital video recorder simultaneously records the information captured by more than one of said video cameras.

18. The communication system in accordance with claim 16, wherein said digital video recorder simultaneously records the information captured by more than one of said video cameras.

19. The communication system in accordance with claim 11, wherein said information recorded in said digital video recorder is both video and audio.

20. The communication system in accordance with claim 11, wherein said carrying case is provided with a plurality of switches for controlling the operation of said video monitor and said digital video recorders through said control device.
